(19) United States
(12) Patent Application Publication
(10) Pub. No.: US 2008/0212564 A1
(43) Pub. Date: Sep. 4, 2008

(54) Clock Synchronization Method For Wireless 1394 Heterogeneous Networks

(75) Inventors: Seong-Hee Lee, Seoul (KR); Seong-Hee Park, Daejon (KR); Sang-Sung Choi, Daejon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejon (KR)

(21) Appl. No.: 11/994,453

(22) PCT Filed: Jul. 18, 2006
(86) PCT No.: PCT/KR06/02803

§ 371 Date: Jan. 2, 2008

(30) Foreign Application Priority Data
Nov. 17, 2005 (KR) 10-2005-0110285

(51) Int. Cl. H04J 3/06

(52) U.S. Cl. 370/350

(57) ABSTRACT

Provided is a clock synchronization method in a heterogeneous network. The method includes the steps of: at a cycle master, transferring a cycle begin packet with a current time to a transmitting-side bridge; at the transmitting-side bridge, synchronizing using the time included in the cycle begin packet and a time to transmit the cycle begin packet, and transmitting the cycle begin packet with a first synchronization time to a wireless 1394 coordinator; at the wireless 1394 coordinator, synchronizing using the first synchronization time and calculating a second synchronization time; at the wireless 1394 coordinator, transmitting the beacon frame with a created information element structure to a receiving side bridge on a wired IEEE 1394 network; at the receiving bridge, synchronizing using the second synchronization time and calculating a third synchronization time; and at the receiving-side bridge, synchronizing the heterogeneous network by transferring the third synchronization time to the receiving node.

### TECHNICAL FIELD

The present invention relates to a clock synchronization method in a heterogeneous network environment using a wireless IEEE 1394 protocol; and more particularly, to a method for synchronizing a clock in a heterogeneous network using a wireless IEEE 1394 protocol for guaranteeing the successful transmission of isochronous data between nodes using the IEEE 1394 protocol and for expanding a single network domain belonged to a single protocol into a plurality of network domains in a heterogeneous network constituted of an IEEE 1394 wired network and a wireless network, for example, IEEE 802.15.3 network.

### BACKGROUND ART

In an embodiment of the present invention, an IEEE 802.15.3 network is described as a wireless network that serves as a medium in a wireless IEEE 1394 network system. However, the present invention is not limited thereby.

Generally, a wireless IEEE 1394 network system is a system constituted through a protocol matching of IEEE 1394 and a wireless technology. In the wireless IEEE 1394 network system, a wired area is accessed using IEEE 1394 and a wireless area is accessed using UWB.

The wireless IEEE 1394 network system synchronizes the clocks of networks using different protocols such as a wired network and a wireless network through a bridge. Herein, the bridge connects more than two networks that use different protocols.

Nodes in IEEE 802.15.3 wireless network environment use a clock synchronous method that is commonly used for the IEEE 1394 protocol in order to process isochronous data transmitted through IEEE 1394 application programs.

Since these nodes are belonged to the IEEE 802.15.3 wireless network environment, the clock cycle of IEEE 1394 application program must be adjusted using a clock synchronization method used in IEEE 802.15.3 network.

Therefore, a node serving as a bridge must create a beacon frame as a node that manages the IEEE 1394 network from the IEEE 802.15.3 network because the node that serving as the bridge is belonged into both of IEEE 802.15.3 network and IEEE 1394 network. Herein, the beacon frame is a data packet used when the clock is synchronized with IEEE 1394 network at the IEEE 802.15.3 network.

As described above, the conventional clock synchronizing technology may be shown as a synchronization method for a heterogeneous network. However, in the real network environment, the node severing as the bridge must play as a piconet coordinator to synchronize the clocks in the IEEE 802.15.3 network. Herein, the piconet denotes a network using the IEEE 802.15.3 protocol, and the piconet coordinator takes a full charge of synchronization in the IEEE 802.15.3 network.

However, the real synchronization method for the heterogeneous network must have a capability to synchronize the clock even when the bridge only plays as the bridge itself that connects a wired network and a wireless network.

Therefore, there is a demand for a new synchronization method that synchronizes clocks in the heterogeneous network when more than two nodes that use the wired IEEE 1394 environment and placed at different locations transmit or receive isochronous data through the IEEE 802.15.3 wireless network. That is, there is a demand for a method that informs a wireless network with the IEEE 1394 bus clock time of a current wired environment.

### DISCLOSURE OF INVENTION

### Technical Problem

It is, therefore, an object of the present invention to provide a method for synchronizing a clock in a heterogeneous network using a wireless IEEE 1394 protocol for guaranteeing the successful transmission of isochronous data between nodes using the IEEE 1394 protocol and for expanding a single network domain belonged to a single protocol into a plurality of network domains by transferring synchronization time information with regarding to an arriving time of a packet from a transmitting node using IEEE 1394 protocol to a receiving node using other IEEE 1394 protocol through a wireless network in a heterogeneous network constituted of an IEEE 1394 wired network and a wireless network, for example, IEEE 802.15.4 network.

### Technical Solution

In accordance with one aspect of the present invention, there is provided a method for synchronizing a clock time in a heterogeneous network environment using a wireless IEEE 1394 protocol, the method including the steps of: a) at a cycle master, transferring a cycle begin packet with a current time to a transmitting-side bridge; b) at the transmitting-side bridge, performing a synchronization operation using the time included in the cycle begin packet and a time taking to transmit the cycle begin packet, creating a first synchronization time, inserting the created first synchronization time into the cycle begin packet and transmitting the cycle begin packet to a wireless 1394 coordinator; c) at the wireless 1394 coordinator, performing a synchronization operation using the first synchronization time in the cycle begin packet, and calculating a second synchronization time with regarding to a time to arrive a receiving-side wired IEEE 1394 network with the first synchronization time; d) at the wireless 1394 coordinator, creating an information element structure using the second synchronization time, inserting the created information element structure into a beacon frame, and transmitting the beacon frame to a receiving-side bridge on a wired IEEE 1394 network; e) at the receiving bridge, performing a synchronization operation using the second synchronization time in the cycle begin packet, and calculating a third synchronization time with regarding to a time to reach a receiving node with the second synchronization time; and f) at the receiving-side bridge, synchronizing the heterogeneous network by transferring the third synchronization time to the receiving node.

### Advantageous Effects

A method for synchronizing a clock in a heterogeneous network using a wireless IEEE 1394 protocol in accordance with the present invention can guarantee the successful transmission of isochronous data between nodes using the IEEE 1394 protocol and can expand a single network domain belonged to a single protocol into a plurality of network domains by transferring synchronization time information with regarding to an arriving time of a packet from a transmitting node using IEEE 1394 protocol to a receiving node using other IEEE 1394 protocol through a wireless network in a heterogeneous network constituted of an IEEE 1394 wired network and a wireless network, for example, IEEE 802.15.4 network.

Furthermore, the method for synchronizing a clock in a heterogeneous network using a wireless IEEE 1394 protocol in accordance with the present invention defines how a clock time is synchronized for a network using a wireless 1394 protocol to smoothly exchange data to a heterogeneous network using a different protocol.

Therefore, isochronous guaranteed multimedia data transmission can be provided in a future home network environment having a complex network structure, and it is expected that the usability of the synchronization method according to the present invention will be maximized.

### BRIEF DESCRIPTION OF THE DRAWINGS

The above and other objects and features of the present invention will become apparent from the following description of the preferred embodiments given in conjunction with the accompanying drawings, in which:

FIG. 1 shows a heterogeneous network system using a wireless IEEE 1394 protocol where the present invention is applied;

FIG. 2 is a flowchart showing a method for synchronizing a clock time in a heterogeneous network environment using a wireless IEEE 1394 protocol in accordance with an embodiment of the present invention;

FIG. 3 shows a structure of a beacon frame in accordance with an embodiment of the present invention; and

FIG. 4 shows an information element structure in accordance with an embodiment of the present invention.

### BEST MODE FOR CARRYING OUT THE INVENTION

Other objects and aspects of the invention will become apparent from the following description of the embodiments with reference to the accompanying drawings, which is set forth hereinafter.

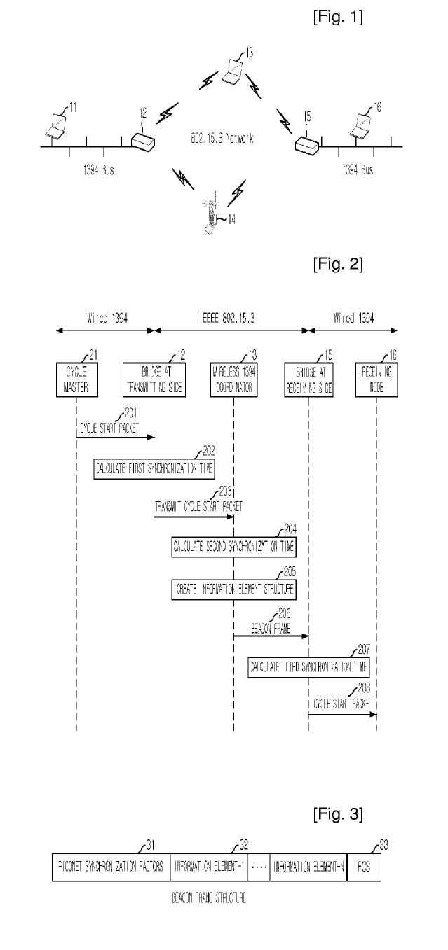

FIG. 1 shows a heterogeneous network system using a wireless IEEE 1394 protocol where the present invention is applied.

As shown in FIG. 1, the heterogeneous network system using the wireless IEEE 1394 protocol includes a transmitting node 11, a transmitting-side bridge 12, a piconet coordinator 13 of an IEEE 802.15.3 wireless network, a wireless node 14, a receiving-side bridge 15, and a receiving node 16. The transmitting node is located on a wired IEEE 1394 bus network and transmits data. The transmitting-side bridge 12 connects the wired IEEE 1394 bus network to the wireless IEEE 802.15.3 network. The piconet coordinator 13 manages overall data flow in the IEEE 802.15.3 wireless network, and manages information about nodes that newly access the own IEEE 802.15.3 wireless network or nodes that become disconnected the IEEE 802.15.3. The piconet coordinator 13 also synchronizes networks in order to adjust clock times of nodes to a single reference time using a beacon frame for smoothly processing the communication data. The wireless node 13 transmits and receives data through a wireless link. The receiving-side bridge 15 connects a wireless IEEE 802.15.3 network to an IEEE 1394 bus network in other wired environment. The receiving node 16 is located on the other wired IEEE 1394 bus network, and receives data from the transmitting node 11.

The beacon frame is a control packet that is regularly transmitted by the piconet coordinator to all of nodes in a corresponding network. Each of the nodes analyzes overall network state using information included in the beacon frame and synchronizes a network time.

FIG. 2 is a flowchart showing a method for synchronizing a clock time in a heterogeneous network environment using a wireless IEEE 1394 protocol in accordance with an embodiment of the present invention.

Referring to FIG. 2, a cycle master 21 denotes a node located in the IEEE 1394 network of all wired environments. For example, the transmitting node 11 functions as the cycle master 21 in the transmitting side, and the receiving node 16 functions as the cycle master 21 in the receiving side in the present invention. The cycle master 21 enables the overall IEEE 1394 bus to be driven with reference to a single timer by synchronizing the clock time of a corresponding network.

That is, the cycle master 21 creates a cycle begin packet with a time generated by a clock timer of the cycle master 21, and transmits the created cycle begin packet to the transmitting-side bridge 12 at step S201.

Then, the transmitting-side bridge 12 performs a synchronization operation using a final time that is calculated by adding a time taking to reach the transmitting-side bridge 12 itself and the time included in the cycle begin packet transmitted from the cycle master 21. After synchronizing, a first synchronization time is calculated at step S202 by adding the final time to a transmit time that is a time taking to reach the wireless 1394 coordinator 13 of the wireless IEEE 802.15.3, where the first synchronization time denotes a 1394 network time at the transmitting-side.

Then, the transmitting-side bridge 12 creates a synchronization time informing packet with the created first synchronization time, and transmits the created synchronization time informing packet to the wireless 1394 coordinator 13 of the wireless IEEE 802.15.3 at step S203.

Then, the wireless 1394 coordinator 13 performs a synchronization operation using the first synchronization time included in the synchronization time informing packet, and calculates a second synchronization time that denotes a wireless network time by adding the first synchronization time to a time taking to reach to the IEEE 1394 network of the receiving side wired environment at step S204. The second synchronization time includes an internal processing time taking to create an information element structure.

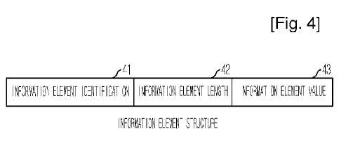

After calculating the second synchronization time, the wireless 1394 coordinator 26 creates the information element structure as shown in FIG. 4 using the second synchronization time information at step S206.

Then, the receiving-side bridge 15 performs a synchronization operation using the second synchronization time in the beacon frame received from the wireless 1394 coordinator 26, and calculates a third synchronization time by adding the second synchronization time to a time taking to reach at the receiving node 16 at step S207, where the third synchronization time denotes a 1394 network time at a receiving side.

The third synchronization time is inserted into the cycle begin packet, and the cycle begin packet is transferred to the receiving node 16 at step S208.

After transferring, the receiving node 16 performs a synchronization operation using the transferred third synchronization time.

The clock time between the networks in the overall heterogeneous network is synchronized through the above-described method.

Meanwhile, the first, the second and the third synchronization times can be expressed as follows.

(1) the 1394 network time at the transmitting-side which is the first synchronization time=a network time included in a cycle begin packet+a time taking to transmit the cycle begin packet from the cycle master to itself+a time taking to transmit the cycle begin packet to the wireless 1394 coordinator

(2) the 802.15.3 wireless network time which is the second synchronization time=a network time included in a synchronization time informing packet+an internal processing time for creating an information element structure by a coordinator+a time taking to transmit a beacon frame from the coordinator to the wireless node.

(3) the 1394 network time at the receiving-side with is the third synchronization=a 802.15.3 wireless network time included in a beacon frame+a time taking to transmit a cycle begin packet to the receiving node.

FIG. 3 shows a structure of a beacon frame in accordance with an embodiment of the present invention.

As shown in FIG. 3, the beacon frame according to the present embodiment includes piconet synchronization factors, a plurality of information elements and frame check sequence (FCS).

The piconet denotes a network using the IEEE 802.15.3 protocol, and the piconet synchronization factors 31 denote various network information used for synchronization in the IEEE 802.15.3 network.

The information elements 32 are network information fields which can be additionally added into the beacon frame, and stores network synchronization time information transferred from the IEEE 394 bus network.

FIG. 4 shows an information element structure in accordance with an embodiment of the present invention.

As shown in FIG. 4, the information element structure includes an information element identifier 41, an information element length 42 and an information element value 43.

The information element identifier 41 is a field for storing a synchronization time information.

The information element length 42 is a field for storing the size information of the information element value.

The information element value 43 is a field for storing the real information element value.

The above-described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean patent application No. 2005-0110285, filed in the Korean Intellectual Property Office on Nov. 17, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. A method for synchronizing a clock time in a heterogeneous network environment using a wireless IEEE 1394 protocol, comprising the steps of:
a) at a cycle master, transferring a cycle begin packet with a current time to a transmitting-side bridge;
b) at the transmitting-side bridge, performing a synchronization operation using the time included in the cycle begin packet and a time taking to transmit the cycle begin packet, creating a first synchronization time, inserting the created first synchronization time into the cycle begin packet and transmitting the cycle begin packet to a wireless 1394 coordinator;
c) at the wireless 1394 coordinator, performing a synchronization operation using the first synchronization time in the cycle begin packet, and calculating a second synchronization time with regarding to a time to arrive a receiving-side wired IEEE 1394 network with the first synchronization time;
d) at the wireless 1394 coordinator, creating an information element structure using the second synchronization time, inserting the created information element structure into a beacon frame, and transmitting the beacon frame to a receiving-side bridge on a wired IEEE 1394 network;
e) at the receiving bridge, performing a synchronization operation using the second synchronization time in the cycle begin packet, and calculating a third synchronization time with regarding to a time to reach a receiving node with the second synchronization time; and
f) at the receiving-side bridge, synchronizing the heterogeneous network by transferring the third synchronization time to the receiving node.

2. The method as recited in claim 1, wherein the first synchronization time includes a network time included in the cycle begin packet, a time taking to transmit the cycle begin packet from the cycle master, and a time taking to transmit the cycle begin packet to the wireless 1394 coordinator, the second synchronization time includes the first synchronization time, an internal processing time for creating the information element structure, and a time taking to reach a receiving-side bridge of the wireless IEEE 1394 network, and the third synchronization includes the second synchronization time and a time taking to reach the receiving node.

3. The method as recited in claim 1, wherein the beacon frame includes piconet synchronization factors denoting various network information used for synchronization in the IEEE 802.15.3 network, a plurality of information element structures, and a frame check sequence (FCS).

4. The method as recited in claim 3, wherein the information element structure includes an information element identifier field for denoting synchronization time information, an information element length field for denoting size information of an information element value, and an information element value field for denoting a real information element value.
